(19) United States
(12) Patent Application Publication
(10) Pub. No.: US 2022/0335330 A1
(43) Pub. Date: Oct. 20, 2022

(54) MANAGING SIMULATORS IN A MULTI-SIMULATOR SYSTEM

(71) Applicant: Microsoft Technology Licensing, LLC, Redmond, WA (US)

(72) Inventors: Jaroslaw RZEPECKI, Cambridge (GB); Raluca GEORGESCU, London (GB); Katja HOFMANN, Cambridge (GB); Adrian O'GRADY, Cambridge (GB)

(21) Appl. No.: 17/339,921

(22) Filed: Jun. 4, 2021

(30) Foreign Application Priority Data
Apr. 15, 2021 (GB) 2105358.2

(51) Int. Cl. G06N 20/00; G06F 30/20

(52) U.S. Cl. CPC G06N 20/00; G06F 30/20

(57) ABSTRACT

A system comprising a set of multiple simulators. Either: a) each simulator performs a different respective trial of a simulation of a same physical phenomenon, or b) each simulator comprises a different instance of a piece of software arranged to automatically perform a different trial of a simulation of using a same functionality of the software. The system further comprises: a control interface configured to collect respective simulation results from at least some of the simulators, and return the collected simulation results to a consumer. The consumer comprises a machine learning algorithm arranged to train a machine learning model using the simulation results supplied by the control interface. The control interface is further configured to detect a state of each of the simulators, and in response to detecting a faulty state of a faulty simulator from amongst the set of the simulators, reset the faulty simulator.

### Cross-Reference To Related Application

This non-provisional utility application claims priority to GB patent application number 2105358.2 entitled “MANAGING SIMULATORS IN A MULTI-SIMULATOR SYSTEM” and filed on Apr. 15, 2021 which is incorporated herein in its entirety by reference.

### Background

There are many situations where software simulators are used to generate data. Such situations include sample collection for reinforcement learning, collecting telemetry from simulators to gather statistics about operation of a system they are simulating, and even testing the simulators themselves.

One or more simulators may be used as part of a given experiment. In the case of multiple simulators, these may be arranged to run on the same server unit or multiple server units networked together (e.g. different rack units or server towers, different racks, or even different data centres located at different geographical sites). A process may be set up to gather the simulation results from the multiple different simulators. This process may run on the same server unit as one or more of the simulators or a different server or computer connected to the simulators via a network.

As an example application, each of multiple simulators in a given experiment may simulate the playing of the same computer game, e.g. a computer game that is under development, with the simulations being used to test the computer game under different playing scenarios before release. In some such applications, the game inputs to each simulator may be provided by an artificial intelligence (AI) agent, and the returned simulation results may be used to train the agent, e.g. using machine learning techniques such as reinforcement learning.

### Summary

In a situation where data is collected from multiple simulators it would be desirable that the data collection process is robust to failures in one or more of the simulators. However existing processes are designed on the assumption that the simulators are very stable. It is recognized here that this is not necessarily the case. If the experiment runs for a long time (e.g. months), then over time more and more simulators may become faulty (e.g. crash), and then the overall efficiency of the experiment will gradually decrease with time as a smaller and smaller proportion of the simulators remain functional. If the results are being used to train a machine learning model, this means the efficacy of the training will gradually wane over time.

According to one aspect disclosed herein, there is provided a system comprising a set of multiple simulators wherein either: a) each of the simulators is arranged to perform a different respective trial of a simulation of a same physical phenomenon, orb) each of the simulators comprises a different instance of a piece of software arranged to automatically perform a different trial of a simulation of using a same functionality of the software. The system further comprises a control interface configured to collect respective simulation results from at least some of the set of simulators, and return the collected simulation results to a consumer, the consumer comprising a machine learning algorithm arranged to train a machine learning model using the simulation results supplied by the control interface. The control interface is further configured to detect a state of each of the simulators, and in response to detecting a faulty state of a faulty simulator from amongst the set of the simulators, reset the faulty simulator.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of the present disclosure and to show how embodiments may be put into effect, reference is made by way of example to the accompanying drawings in which:

FIG. 1 is a schematic block diagram of a system comprising an experiment manager for managing multiple simulators in accordance with embodiments disclosed herein,

FIG. 2 is a schematic block diagram illustrating one example of a possible implementation of the system of FIG. 1,

FIG. 3 is a flow chart showing a method that may be performed by an experiment manager according to embodiments disclosed herein,

FIG. 4 is a schematic block diagram representing a failure environment and simulation environment in accordance with embodiments disclosed herein, and

FIG. 5 is a flow diagram of a method of training a machine learning model in accordance with embodiments disclosed herein.

### DETAILED DESCRIPTION OF EMBODIMENTS

As mentioned, there are many situations where software simulators are used to generate data to be collected. Those situations include sample collection for reinforcement learning, collecting telemetry from simulators to gather statistics about operation of a system they are simulating, and testing the simulators themselves.

In situations where data is collected from simulators it would be desirable that the data collection system is robust to any failures in (some) of the simulators. Moreover for the overall efficiency of the system it would be desirable that the failed simulators are automatically restarted to a working state and keep on producing data. The present disclosure provides a framework which provides fault tolerance in respect to any number of individual simulator failures. The framework comprises:

i. a monitoring component deployed to all the simulator machines which is responsible for monitoring the health of the simulators and restarting them if necessary;

ii. an interface that allows for:
a. receiving of data from simulators, and
b. sending control commands to all the individual simulators (and in embodiments different simulators may receive different commands);

iii. sending of query requests about the state of the simulators.

In embodiments new data (e.g. a new model of an AI agent) can also be sent to all the simulators — i.e. simulators can receive new data that affects the simulation.

The data received from the simulators may be supplied to a consumer which may be a human user or any software (e.g. a database or an algorithm) that consumes data produced by the simulators. For example the consumer may comprise a machine learning (ML) algorithm and a ML model whereby the ML algorithm is configured to train the ML model using the data received from the simulators. In embodiments the control commands and/or query requests may originate from the consumer.

Preferably the framework also allows for scaling the number of simulators. In embodiments the framework may comprise:

iv. a scalable architecture component used to run the simulators (e.g. an Azure ScaleSet of Windows machines);

v. a scalable architecture component used to run the consumer software (e.g. an Azure Scaleset of compute machines, or kubernetes cluster for example).

There are other solutions that correspond to point v. above — in that they provide a scalable consumer. Those solution include Ray RLlib software or any vectorized RL training framework running on kubernetes. However those solutions assume that the simulators are cheap to run and can run on the same machine or cluster as the consumer. Moreover they assume that the simulators are very stable.

Embodiments disclosed herein combine the flexibility of scaling the consumer compute power with the ability to run expensive (from computational point of view) simulators on separate machines than the consumer. Additionally, an interface is provided which rings all this together and provides stability and robustness in the case of simulators failure.

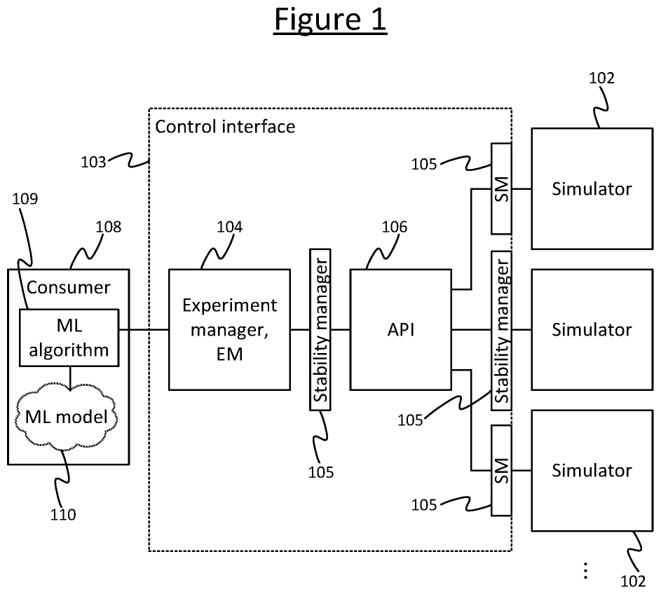

FIG. 1 shows a system in accordance with embodiments disclosed herein. The system comprises a set of simulators 102, a control interface 103, and a consumer 108. The set of simulators comprises multiple (i.e. a plurality of) simulators 102. Three are shown for illustrative purposes, but it will be appreciated that there may be any plural number of simulators 102 in the set. By way of example, the set may comprise 10 simulators, 100 simulators, or 1000 simulators. In principle there is no upper limit. Each of the simulators 102 takes the form of a piece of software configured to simulate either a real-world phenomenon or the running of a piece of target software (e.g. a game under development). The possibility of simulators implemented in hardware (e.g. fixed function circuitry) is also not excluded. In the case of software, the different simulators 102 of the set may be implemented on the same server unit or different server units, or a combination of some on the same server unit and some on different server units. Different ones of the simulators 102 may run in parallel with one another (i.e. overlapping in time), thus enabling them a larger amount of simulation results in a given time compared to running only a single simulator.

The simulators 102 of the set may all simulate the same phenomenon or piece of software. In embodiments the simulators 102 of the set may all be part of the same experiment.

In the case of simulating a physical phenomenon (i.e. a physical or real-world process or effect, as opposed to virtual), then each simulator 102 is arranged to perform a different trial of the simulation, i.e. to model the same phenomenon but under conditions of a different respective set of values of one or more internal or external parameters of the modelled phenomenon. In other words each simulator 102 performs a different instance of the simulation of the same phenomenon. For example if the phenomenon is characterized by one or more settable internal parameters, and/or affected by one or more settable external parameters, then the different instances could be set to run with a different value or set of values of the one or more controllable parameters. And/or, if the phenomenon is characterized by one or more internal random parameters, and or affected by one or more random external parameters, then the different instances of the simulation may simply be allowed to run and in doing so will tend to take different values of the one or more random parameters according to whatever pseudo-random algorithm is used to model the randomness of the phenomenon.

An example of simulations modelling physical phenomena would be physics simulations of complex processes, e.g. nanophysics, that can be simulated locally to measure global properties (e.g., material properties). Another example is simulation of individual agent behaviours to study emergent phenomena in population or crowd dynamics. Another example would be to model the behaviours of certain combinations of molecules or chemicals such for the purpose of drug development.

Another example setting would be where the simulators 102 run a physics simulation of an engineering system (e.g. a force or stress analysis of a hardware part). The model of the part has a large number of parameters (e.g. composition of steel used, thickness of joints, temperature, etc) and the goal is to find optimal set of parameters that provide maximal strength of the component at a given manufacturing cost. The simulators would apply forces to the current model of the part and send data back to the controller 104, and that data is then processed to decide what next set of parameters to test in order to find optimal solution.

In the case of simulating a piece of software, such as a game, then each simulator 102 comprises a different instance of the same piece of software, arranged to run automatically to simulate use of the software (e.g. to automatically simulate the use as if by one or more human users). Each simulator 102 simulates the use under a different circumstance (e.g. different software state or condition). For example if the software takes one or more settable parameters, then the different instances could be set to run with a different value or set of values of the one or more settable parameters. These could represent one or more internal conditions or states of the software. And/or, if the software takes one or more inputs (e.g. user inputs, such as game inputs) then each simulator 102 may simulate the use of the software under conditions of a different value or set of values of the one or more inputs. As another alternative or additional example, if the software comprises one or more pseudo random parameters, then the different instances of the simulation may simply be allowed to run and in doing so will tend to take different values of the one or more random parameters according to whatever pseudo-random algorithm is to model randomness in the software. Note also: where it said herein that the simulation runs automatically or such like, and the piece of software being simulated is one that would normally take one or more user inputs, then this means the simulator 102 (i.e. automated instance of the software) automatically generates the value(s) of at least one of the user inputs, to simulate use by the user.

As an example application in the software case, each simulator 102 may be an instance of the same computer game configured to simulate the playing of the game by a player. In other words the game is played automatically, e.g. by an Al agent, in order to simulate the playing of the game, rather than it being played manually by a human player. In embodiments the agent may also be trained based on the simulations, e.g. using reinforcement learning. And/or, other than training to play the game, the agent may be performing other tasks in the game —for example finding bugs, or finding visual artifacts, or testing the stability of the game.

The control in interface 103 is arranged to collect data from the simulators 102. The collected data includes at least some simulation results (e.g. game outcomes) resulting from the simulations being conducted by the simulators. The collected simulation results could be some or all of the simulation results generated by each simulator 102 (or at least each non- faulty simulator in the set). The control interface 103 is also arranged to control the simulators 102, such as to start of stop individual simulators, or add or remove them from the set.

The control interface 103 may take the form of software implemented on computer equipment comprising one or more computer units (e.g. one or more server units). The possibility of the control interface 103 being implemented partially or wholly in hardware (e.g. fixed function circuitry) is also not excluded.

In embodiments, the control interface 103 may comprise: an experiment manager (EM) 104, a stability manager (SM) 105, and an application programming interface (API) 106.

The experiment manager (EM) 104 is responsible for collecting the simulation results from the simulators 102 and supplying them to the consumer 108. In order to be able to collect the data from the simulators 102, the experiment manager 104 is operatively coupled to each of the simulators 102 in the set via an application programming interface (API) 106. The API provides a protocol for interacting between the EM 104 and the simulators 102.

The stability manager (SM) 105 is responsible for detecting when simulators 102 fail and resetting them. The stability manager 105 may be implemented on the same side of the API 106 as the experiment manager (EM) 104, in which case it detects the state of the simulators 102 and controls them to reset via the API 106. Alternatively the stability manager 105 may be implemented as a one or more stability manager instances the same side of the API 106 as the simulators 102 (e.g. an instance on each server or virtual machine that hosts one or more of the simulators 102). In this case the stability manager 105 may detect the simulator states and control the simulators 102 directly, and return simulation results from the simulators to the EM 104 via the API 106. Both options are shown in FIG. 1 but it will be appreciated that only one of the two options may be implemented in any given embodiment.

The consumer 108 comprises a machine learning model 110 such as a neural network and a machine learning algorithm 109 such as a back propagation algorithm that is arranged to train the ML model based on the simulation results from the simulators 102. In embodiments the training algorithm may employ reinforcement learning. The consumer 108 may be implemented on one or more of the same computer unit(s) as the control interface 103 or on one or more separate computer units, or a combination. The consumer 108 may for example be implemented on a server or a computer terminal. The possibility is also not excluded that the consumer 108 is implemented partially or wholly in hardware (e.g. fixed function circuitry).

In embodiments any one or both of the control interface 103 and consumer 108 may be implemented on one or more of the same server units as any one or more simulators 102, or on separate computer units or devices, or a combination. In embodiments any or all of the simulators 102, EM 104, SM 105, API 106 and consumer 108 may be implemented on one or more of the same server units as one another, or on separate computer units or devices, or a combination.

When any of the components (simulators 102, control interface 103, EM 104, SM 105, API 106 and/or consumer 108) are implemented in software, they may be stored in any one or more storage (memory) media of their respective computer units or units, e.g. a magnetic medium such as a hard disk or magnetic tape; or an electronic medium such as ROM, EEPROM, flash memory, DRAM, etc.; or an optical medium such as an optical disk or quartz glass storage; or any combination of these and/or other storage technologies. The software components 102, 103 104, 105, 106 and/or 108 may each be arranged to run on one or more processors of their respective computer units. The processor(s) in question could take any known form, e.g. a general purpose processor such as a central processing unit; or an application specific or accelerator processor such as a graphics processing unit (GPU), digital signal processor (DSP), cryptoprocessor, or AI accelerator processor. Another possibility is it implement in configurable or reconfigurable circuitry such as a programmable gate array (PGA) or field programmable gate array (FPGA).

When any of the components (e.g. simulators 102, control interface 103, EM 104, SM 105, API 106 and/or consumer 108) are to be operatively coupled to one another but implemented on separate computer units or devices (e.g. separate server units), they may be networked together using any one or more known network technologies, e.g. the Internet, or a mobile cellular network such as a 3G, 4G or 5G network, or a local area wired or wireless network such as a Wi-Fi or Ethernet network, or a storage area network, or any combination of these and/or other technologies.

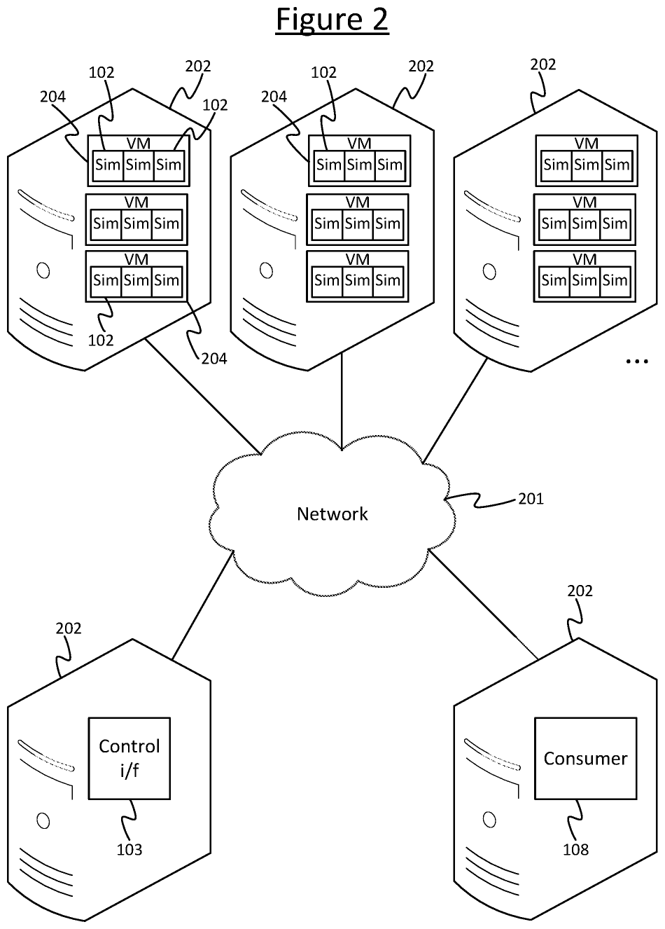

FIG. 2 shows an example implementation of the system of FIG. 1. Each of the simulators may take the form of a piece of software run on a virtual machine (VM) 204, each virtual machine being implemented on a server unit 202. In embodiments the system may comprise a plurality of virtual machines 204, which may be run on the same server unit 102, or different server units 202, or some on the same server unit and some on different server units. The set of simulators 102 may run on the same virtual machine 204, or each on a different virtual machine 204, or some simulators 102 on the same virtual machine and some on different virtual machines. In embodiments a different respective subset of the simulators 102 is run on a different a respective VM 204, each subset comprising some (a plurality) but not all of the simulators 102 of the set.

Each server unit 202 may for example take the form of a rack unit, or a tower server, or any known form. It will be appreciated that the form of illustration used in FIG. 2 is merely to be taken as schematic in this respect. In embodiments the server units 202 may comprise a plurality of units in the same rack, server units in different racks in the same data centre, or server units in different data centres at different geographical sites (a so-called “cloud” arrangement).

By way of example, FIG. 2 shows each of the control interface 103 and consumer 108 running on a separate respective server unit 202. This is one possibility. However, in other arrangements, any combination or all of the components 103, 104, 105, 106, 108 could be run on any one or more of the same server units 202 as one another, and/or as any one or more of the simulators 102 or virtual machines 204. As another possibility, the control interface 103 and/or consumer 108, or any part thereof, may be implemented on a computer terminal such as a desktop or laptop computer, tablet, or even smartphone or wearable device.

When any of the components (simulators 102, control interface 103, EM 104, SM 105, API 106 and/or consumer 108) are implemented on different computer units and are required to interact with another of the components 102, 103, 104, 105, 106, 108 in accordance with the arrangement shown in FIG. 1 and/or the example processes described in more detail shortly, then the interaction may be conducted via a network 201 to which the respective computer units (e.g. server units 202) are connected. The network 201 may comprise one or more constituent networks. For instance, the network 201 may comprise any one or more of: the Internet; one or more mobile cellular networks such as a 2G, 3G, 4G or 5G network, etc.; one or more local area wired networks such as a Wi-Fi, Bluetooth, ZigBee or 6LoPAN network, etc.; a wired local area network such as an Ethernet network, token ring network, fibre network, power line modulation network, etc.; or any other form of network such as a campus area network, metropolitan area network, etc.

In embodiments the server units 202 may be configured to employ load balancing, such that simulators 102 can be migrated between different VMs 204 and/or server units 202 in order to even out the processing resources incurred by the simulators 102. The load balancing may be performed automatically by a load balancing process (not shown), which could be implemented in the control interface 103 (e.g. in the EM 104), or as a separate centralized entity run on one or more master server units 202, or could be a distributed process run on each of the server units 102 over which load balancing is performed. The load balancing process may be implemented in software run on the server unit(s) 202 in question, or in principle a hardware load balancer is also not excluded.

In some embodiments, the simulators 102 may be arranged into flexible clusters of VMs 204. A cluster is a group of heterogeneous load-balanced virtual machines. E.g. the clusters may be Azure Scale Sets.

In operation, the EM 104 collects respective simulation results from the simulators 102, or at least those that are operational. This may comprise the EM 104 passively waiting for results from the simulators 102. Alternatively the EM 104 may actively send out queries to each of the simulators 102, and in response receives back respective simulation results from the simulators 102, or at least those that are properly operational. These communications are conducted via the API 106 (and any network 201 involved in communicating between the EM and API 106, and/or between the API 106 and simulators 102). The API 106 also enables the EM 104 to control the simulators 102, such as to restart them, or to add or remove simulators 102 to/from the set. The API 106 provides a protocol for communicating with the simulators 102 and controlling them. In embodiments, the API 106 may for example comprise RPC (Remote Procedure Call) or ZMQ (Zero Message Query), which are generic network communication protocols that enable one entity to control another over a network 201. For completeness, note also that in the case where the network 201 comprises multiple constituent networks, the type of network used between EM 104 and API 106 is not necessarily the same as that used between API 106 and simulators 102.

In embodiments the EM 104 may query each of the simulators 102 in turn in a sequence. Alternatively however it could send some or all of the queries to the different simulators 102 out in parallel. In embodiments the EM 104 may query the simulators 102 periodically, or in response to a certain event, or even randomly. In further alternatives it is not essential that the EM 104 queries the simulators, and instead the simulators 102 may autonomously send simulation results to the EM 104. In this case the simulators 102 may return the results in an uncoordinated manner with respect to one another, or in a coordinated sequence or pattern. They may each return results periodically, or simply whenever results happen to be available.

By whatever means collected, the EM 104 returns the collected results to the consumer 108. It may save up a batch of results from some or all of the simulators and return these results to the consumer 108 as a batch. Alternatively the EM 104 may return the results to the consumer as-and-when they are received from each individual simulator 102. Either way, the EM 104 may return one or more results to the consumer 108 autonomously or in response to a command from the consumer 108. In some embodiments or the latter case, the EM 104 may send the queries to the simulators 102 in response to one or more query requests from the consumer 108. E.g. the consumer 108 may submit a single query request to gather data from all or a subset of the simulators 102 in the set, and in response the EM 104 sends out queries to all the relevant simulators 102. Alternatively or additionally, the consumer 108 may request specific individual simulators 102 to be queried by the EM 104. However as mentioned, the queries are not essential and in other embodiments the EM 104 may await results which are sent autonomously by the simulators 102. By whatever means the results are collected, then once the respective simulation results are received back, the EM 104 may forward the results onward to the consumer 108. If the EM 104 and consumer 108 are implemented on different computer units, the commands (e.g. query requests) from consumer 108 to EM 104 may be communicated via the network 201, and similarly for the forwarding of results from the EM 104 to the consumer 108. For completeness, note that in the case where the network 201 comprises multiple constituent networks, the type of network used between consumer 108 and EM 104 is not necessarily the same as that used between EM 104 and API 106 nor API 106 and simulators 102.

The consumer 108 may comprise a machine learning algorithm 109 requesting training data from the simulators 102 in order to train its respective machine learning model 110 (e.g. AI agent), for example using reinforcement learning. For instance the machine learning model 110 may be a model such as an Al agent that is being trained to automatically operate or interact with a piece of software, such as to play a game. Alternatively or additionally, the agent may be arranged to perform other tasks such as finding bugs or artifacts, or testing the stability of the software. As another example use case, the machine learning algorithm 109 may be arranged to train a ML model 110 of a physical phenomenon being simulated by the simulators 102, such as an engineering or physics problem or a chemical composition (e.g. of a drug under development). In this case the machine learning algorithm 110 may be arranged to train the model of the physical phenomenon based on the results of the simulator, such as to search for a solution to the physics or engineering problem, or to search for a compound having a desired effect (e.g. to treat a medical condition of a human or animal).

In embodiments, each of the simulators 102 may be initialised with a first instance of the machine learning model 110 at the simulator 102, and may be arranged to perform its simulation based on that first instance of the model 110. E.g. the model 110 may comprise an AI agent, and each simulator 102 comprises a different instance of the game arranged to be played by the ML model 110 of the Al agent. If different instances of the game present the model 110 with different game events, or different random parameters, for example, then the different simulators 102 running parallel may quickly generate a large set of training data. This data is returned to the machine learning algorithm 109 via the control interface 103 and used to update the model based on ML training techniques, such as back propagation through a neural network. Similar comments may be apply to other types of model, e.g. a model of a physics or engineering problem or chemical compound may be tested under different simulated circumstances by different simulators 102.

Sometimes one or more of the simulators 102 may become faulty. For example they may crash and thus become unresponsive to queries from the EM 104. As another example, they may remain responsive but unable to return simulation results, e.g. returning instead only an error message. For instance, a communication function of the simulator 102 may remain operational and able to return an error message, but the simulation itself may have become stuck in an erroneous or non-functional state. Another example would be if the simulator 102 was unable to connect to the network 201 (this would require at least part of the SM 105 to be implemented at the simulator side to fix).

The SM 105 is configured to be able to detect one or more such faults, e.g. by detecting that no response has been received after a time-out period, or by detecting that an error message has been received back instead of the respective simulation results.

Upon detecting that one of the simulators 102 is faulty, e.g. unresponsive or returning error messages, the SM105 sends a signal to that simulator 102 (e.g. via the API 106) controlling it to reset. E.g. this may be done using one or more RPC or ZMQ commands. A reset of a simulator 102 herein may refer to any of: i) rebooting the machine on which the simulator is running, ii) restarting the simulator (i.e. restarting the software as opposed to rebooting the machine), or iii) resetting an internal software state of the simulation (not necessarily restarting or resetting the whole simulator program). Generally, a reset of a simulator 102 herein may refer to any action performed by the control interface 103 on a simulator 102 to recreate a stable simulator state.

If there are still other simulators 102 to collect results from, preferably the EM 104 will continue to collect results from one or more of those simulators while waiting for the faulty simulator to reset. E.g. the EM 104 may continue to await results from other simulators 102, or may continue querying one or more of those simulators for their respective simulation data while waiting for the faulty simulator to reset. Once the faulty simulator has been reset, the EM 104 may attempt to query it again for its latest simulation data, or may simply await the new result from the simulator. Alternatively or additionally, upon detecting a faulty simulator 102, the SM 105 may supply the EM 104 with the last good simulation data received from the faulty simulator before the fault was detected. This may be a repetition of data that was already previously supplied to the consumer 108, or some other placeholder data. The EM 104 then supplies this replacement data back to the consumer 108 along with the other simulation results from the other simulators. In some applications it may be useful for the consumer 108 to continue to receive an ongoing stream of data rather than have a gap in the data, e.g. because it requires a fixed size set of data in a predetermined format to be returned per round learning . For instance if the time taken for the simulator to reset and start producing results again is small, then in some applications or scenarios, the old data supplied in the interim may provide a suitable approximation or interpolation of the data lost in the gap. And/or, this feature may be useful, for example, if the consumer software requires all simulators 102 to return data before processing it. E.g. the consumer software may be set up to fill in a table or array with data returned from all simulators and only after the whole table or array is filled can the consumer software process it.

In some such embodiments, the stability manager (SM) 105 is arranged as another layer of interface between the EM 104 and simulators 104. It may be arranged to isolate the EM 104 from the faulty state of the simulators. The EM 104 may send its queries requesting simulation results to the SM 105, and the SM 105 forwards them on to the relevant simulators 102, then returns the requested simulation results from the simulators 102 to the EM 104 once available. The queries and results may be communicated between the SM 105 and the simulators 102 via the API 106, or may be communicated between the EM 104 and SM 105 via the API 106, depending on which side of the API 106 the SM 105 is implemented on. Either way, if the SM 105 detects that one of the simulators 102 is faulty, it will reset the faulty simulator and in the meantime either return the last good result to the EM 104 or wait for the faulty simulator to reset and then return the requested result from the now-reset simulator. This way the EM 104 is isolated or “shielded” from the faulty simulator(s) 102. I.e. the EM 104 does not even need to know that any simulators 102 were faulty. From the perspective of the EM 104, it simply continues to receive results on behalf of all the queried simulators 102 in the required format, which it collects together and returns to the consumer 108.

In some cases, the simulators 102 may be grouped into subsets whereby the simulators 102 in a given subset affect one another or are dependent on one another. For example, each simulator 102 in a subset may comprises a game instance simulating the playing of the same multiplayer computer game session under control a different Al agent of the consumer 108 (the consumer 108 may comprise multiple agents). In such scenarios, then if one of the simulators 102 in the subset fails (e.g. crashes and thus becomes unresponsive), then this may affect the experiment or sub experiment being performed by the whole subset (e.g. the simulated game session is ruined). Therefore in embodiments, in response to detecting a fault in one simulator 102 of a given subset, the SM 105 may reset the whole subset. For example, a subset of simulators 102 run on the same VM 204 may be interdependent, and then it may become necessary to reset all the simulators running on that VM 204.

In embodiments, the EM 104 may additionally be granted the power to add and/or remove simulators 102 from the set or a subset. E.g. it may create a new simulator 102 to add to the set or subset, or destroy a simulator; or merely activate a dormant simulator 102 and flag it as part of the set or subset, or temporarily deactivate a simulator 102 and unflag it as part of the set. To perform such actions the EM 104 signals to the relevant simulator(s) 102 via the API 106, e.g. using one or more RPI or ZMQ commands.

In some such embodiments, the EM 104 may add or remove simulators 102 in order to try to meet (or approximately meet) a computing resource allowance or target allocated to the experiment. The allowance or target may be assigned by the consumer 108, or by some other a resource management process (e.g. run on one or more of the server units 102 or a master unit). If the target or allowance is reduced, then the EM 104 may need to reduce the number of simulators 102 in the set in order to bring the total compute resource incurred by the experiment down to within the allowance or closer to the target. If the target or allowance is increased, then the EM 104 may increase the number of simulators 102 in the set in order to make more use of the increase in allocated resource. The compute resource target or allowance may be defined for example in terms of a number of cycles or operations per unit time, or a total amount of data to be processed, or simply a number of simulators, or any suitable measure of compute resource.

Alternatively or additionally, in some embodiments the SM 105 may remove a simulator 102 from the set if the EM 104 detects one or more repeated faults in the simulator. I.e. if a simulator 102 has to be reset once, and then subsequently has to be reset one or more further times (perhaps within a given time window), then the SM 105 may remove it from the set. A repeated fault may be caused by for example by faulty hardware (e.g. a hardware fault is causing the simulator to keep on rebooting or crashing). The limit for number of resets is a matter of design choice and may depend on the application, but it could be for example be two, three, four, five, ten, twenty or a hundred times (either in total over the whole experiment, or specifically within a certain time period such as a minute, hour, day, week or month).

As another additional or alternative feature, in embodiments the SM 105 may be arranged to periodically reset the simulators 102, irrespective of whether they are faulty. It may reset all the simulators in the set together; or may stagger the timings of the periodic resets so that different individual simulators 102 or different subsets are reset at different respective times, each periodically but with the reset periods of the different simulators 102 or subsets offset with respect to one another. Such a feature may be useful in a system where the simulators gradually slow down. This slowness may be caused by for example by resource leaks such as memory leaks in the simulator (a problem that occurs when a program does not release all resources that it has acquired once used, such as memory allocation). Such leaks will slowly decrease the performance of the simulator so a periodic reboot will help. In this situation, a periodic reset of all simulators will prevent the efficiency of the learning from gradually reducing over time.

As yet another additional or alternative feature, in embodiments the EM 104 may also be configured to send data back to the simulators 102 in order to update the simulation (e.g. send a new ML model to be used on the simulators).

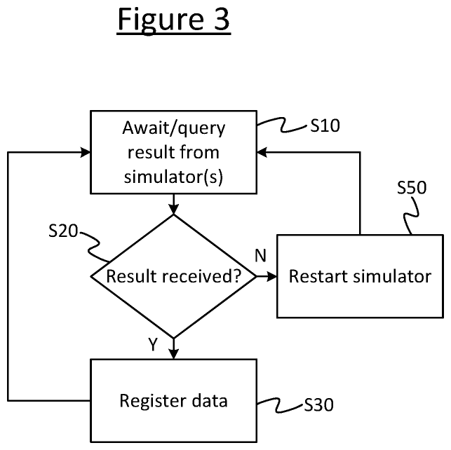

FIG. 3 illustrates an example method that may be performed by the control interface 103 in accordance with embodiments disclosed herein. At step S10 the control interface 103 begins collecting results from one or more of the simulators 102, either by sending a query to at least one of the simulators 102 to request simulation data, or simply by passively awaiting results from simulators. For each simulator, at step S20 the control interface 103 determines whether the simulator 102 has returned a valid response. E.g. this may comprise determining whether a response has been received within a time-out window and therefore whether the simulator has become unresponsive, or it may comprise determining whether the response comprises an error message, or perhaps whether it comprises data of an expected quantity or format.

If the simulator 102 has returned a valid response, then the control interface 103 proceeds to step S30 where it registers the received simulation data. This may comprise logging the data as validly received in the EM's own records, and/or forwarding the received data to the consumer 108. In embodiments the control interface 103 may batch the data first before sending a whole batch at once to the consumer—this can be done for performance reasons for example. For instance a batch of data can be compressed before sending to the consumer 108 to save network bandwidth.

If there are one or more simulators 102 left to collect results from, then the method may loop back to step S10 where it continues to collect results from one or more others of the simulators 102.

If however the simulator did not return a valid response, then the method branches to step S50 where the control interface 103 restarts the faulty simulator 102. In embodiments, the control interface 103 may then loops back to step S10 to continue collecting results from one or more other simulators 102 while waiting for the faulty simulator to reset.

Note that the loop in FIG. 3 may be considered somewhat schematic. In embodiments this “looping” can be done in parallel, or each loop may process the results from multiple simulators in parallel. I.e. the loop does not need to sequentially process the results from each simulator one-by-one.

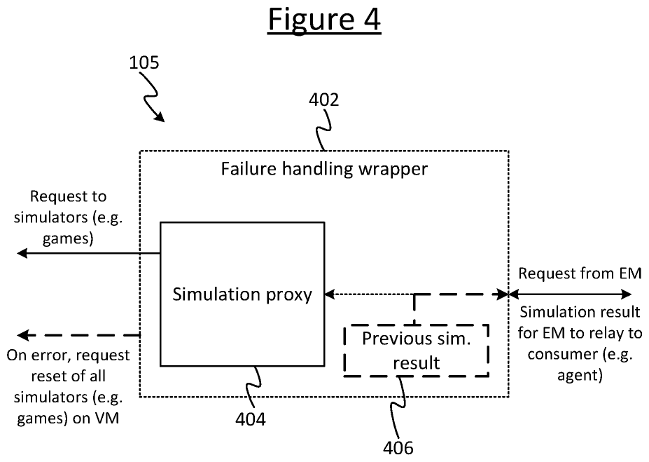

FIG. 4 schematically illustrates a fault handling wrapper 402 provided by the SM 105, to isolate the EM 104 from faults according to one representation of embodiments of the techniques disclosed herein. The fault handling wrapper comprises a simulation proxy 404 which isolates the simulated environment (e.g. game environment) from the EM 104 and consumer 108 (e.g. training script). It also triggers restart of simulators 102 (e.g. game instances) if an error is detected. In embodiments, it may also hide failures from training by returning last good observation 406 and reporting the episode as “done”. An episode in this case is a full completion of a task by a simulator, for example in case of using simulators to train an agent in a game, an episode can be one full game (i.e. in multiplayer death match game it would be the simulation form the beginning of the match till there is a winner of the match).

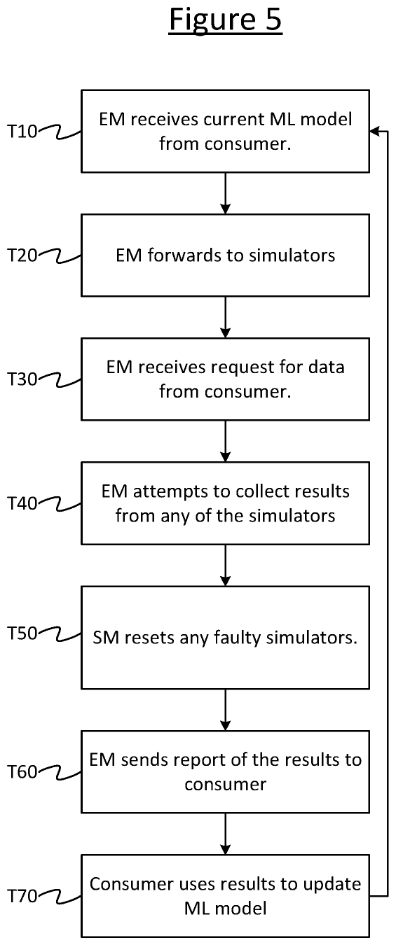

FIG. 5 is a flow chart showing a method of training a machine learning model via the experiment manager (EM) 104 according to embodiments disclosed herein. At step T10 the EM 104 receives from the consumer 108 a current instance of the machine learning model 110. This may be an untrained instance or an instance that has only been partially trained so far. At step T20 the EM 104 forwards the current model to each of the simulators 102. At step T30 the EM 104 receives a request from the consumer 108 for a set of data points with which to train the model 110.

At step T40 the EM 104 begins collecting results from a set of the simulators 102, e.g. by actively sending corresponding queries for simulation results to each of the simulators, or simply by waiting for results from the simulators. In embodiments the EM 104 does not need to collect data from all the simulators in the set, or nor all at once, but rather it just grabs data from any simulator that has data ready. In embodiments the communication between EM104 and simulators 102 at step T40 may be conducted via the SM 105 and API 106. At step T50 the EM 104 receives back the simulation results from each of the simulators 102, or at least those that are not faulty. If any are faulty, this will be detected by the SM 105 which will reset the faulty simulator(s). In the meantime, it may return the last good result from each faulty simulator to the EM 104 in lieu of an actual result. Alternatively it may wait until the faulty simulator 102 has reset, then resubmit a query and get back the requested result, or simply await the next good result, and send this back to the EM 104. In the meantime, the collection of results can continue between the EM 104 and non-faulty simulators.

At step T60, the EM 104 returns the results to the consumer 108. In embodiments it may wait to collect together a full set of results before returning to the consumer 108. Alternatively it may simply return each collected result as-and when received. In some embodiments the EM 104 just waits for enough data being produced from any simulators 102 (i.e. does not wait for all simulators of the set to return data, but rather just waits for enough data being produced regardless of which simulators it comes from).

At step T70 the consumer 108 inputs the received results into the ML algorithm 109 in order to train the ML model 110, e.g. based on reinforcement learning. This training may comprise an initial round of training or updating an already partially-trained model. the method may then loop back to step T10 to update the simulators 102 with the updated version of the ML model 110 and continue the training in an iterative manner.

Note that FIG. 5 is somewhat schematized. In embodiments the EM 104 does not have to wait to receive results from all simulators 102 in the set before the consumer 108 starts using some of the results for updating the model 110. Hence step T70 could be being performed for some simulators 102 of the set while steps T40-T60 are still being performed for some others.

It will be appreciated that the above embodiments have been described by way of example only.

More generally, according to one aspect disclosed herein there is provided a system comprising: a set of multiple simulators wherein either: a) each of the simulators is arranged to perform a different respective trial of a simulation of a same physical phenomenon, or b) each of the simulators comprises a different instance of a piece of software arranged to automatically perform a different trial of a simulation of using a same functionality of the software; and a control interface configured to collect respective simulation results from at least some of the set of simulators, and return the collected simulation results to a consumer, the consumer comprising a machine learning algorithm arranged to train a machine learning model using the simulation results supplied by the control interface; wherein the control interface is further configured to detect a state of each of the simulators, and in response to detecting a faulty state of a faulty simulator from amongst the set of the simulators, reset the faulty simulator.

In embodiments, the faulty state may comprise a non-responsive state whereby the faulty simulator does not respond to the control interface including not returning simulation results.

In embodiments, the control interface may be configured to so as, upon detecting the non-responsive state of the faulty simulator, to continue collecting simulation results from others of the simulators while waiting for the faulty simulator to reset.

In embodiments, each of the simulators of said set may be arranged to perform its respective simulation under control of a first instance of the machine learning model in order to generate the respective simulation results; and the control interface may be further arranged to receive an updated instance of the machine learning model updated based on said training by the machine learning algorithm, and send the updated instance to each of the simulators in the set. Each of the set of simulators may be further arranged to generate one or more further results based on the updated instance of the machine learning model.

In embodiments, the control interface may be configured to perform said collection of simulation results based on one or more query requests from the consumer.

In embodiments, the piece of software which each of the simulators is each configured to simulate may comprise a computer game.

In embodiments, the machine learning model may comprise at least part of at least one artificial intelligence agent being trained to play the computer game, in which case the different circumstances may comprise different values of one or more game inputs.

In embodiments, the control interface may be configured so as, in event of detecting the faulty state, to supply a last-collected simulation result from the faulty simulator to the consumer.

In embodiments, the control interface may be further configured to add simulators to said set and/or remove simulators from said set.

In embodiments, the control interface may be configured to remove one or more of the simulators from the set in response to a computing resource allowance or target for the set being reduced.

In embodiments, the control interface may be configured to add one or more simulators to the set in response to a computing resource allowance or target for the set being increased.

In embodiments, the control interface may be configured to remove the faulty simulator from the set in response to detecting at least one repeated failure of the faulty simulator after being reset.

In embodiments, the control interface may be further configured to periodically reset each of the simulators in said set.

In embodiments, the simulators may be run across multiple virtual machines distributed across a plurality of physical server units of a distributed computing platform.

In embodiments, the simulators may be implemented on one or more clusters, each cluster being a group of heterogeneous load-balanced virtual machines.

In embodiments, the control interface may be further configured to send data to one or more of the set of simulators to update the one or more simulators.

In embodiments, the simulators of said set may be grouped into subsets of simulators wherein within each subset the simulators interact with one another. The control interface may be configured so as in response to detecting the faulty state of the faulty simulator in one of the subsets, to reset all the simulators in the same subset as the faulty simulator.

According to another aspect disclosed herein, there is provided a computer- implemented control interface for controlling a set of multiple simulators wherein either: a) each of the simulators is arranged to perform a different trial of a simulation of a same physical phenomenon, orb) each of the simulators comprises a different instance of a piece of software arranged to automatically perform a different trial simulation of a same functionality of the software; the control interface comprising: an experiment manager; an application programming interface, API, between the experiment manager and simulators; wherein the experiment manager is configured to collect simulation results from at least some of the set of simulators via the API, and return the collected simulation results to a consumer of the simulation results, the consumer comprising a machine learning algorithm being arranged to train a machine learning model using the simulation results supplied by the experiment manager; and a stability manager configured to detect a state of each of the simulators, and in response to detecting a faulty state of a faulty simulator from amongst the set of the simulators, reset the faulty simulator.

According to another aspect disclosed herein, there is provided a method of controlling a set of multiple simulators wherein either: a) each of the simulators is arranged to perform a different trial of a simulation of a same physical phenomenon, or b) each of the simulators comprises a different instance of a piece of software arranged to automatically perform a different trial of a simulation of a same functionality of the software; the method comprising: collecting simulation results from at least some of the set of simulators; supplying the collected simulation results to a machine learning algorithm, thereby causing the machine learning algorithm to train a machine learning model based on the simulation results; detecting a state of each of the simulators in the set; and in response to detecting a faulty state of a faulty simulator from amongst the set of the simulators, reset the faulty simulator.

According to another aspect there is provided a computer program embodied on a non-transitory computer-readable medium or media, the computer program comprising code configured so as when run on one or more processors to perform the operations of the method.

In embodiments the method may further comprise, or the program may be further configured to perform, operations in accordance with any of the system features disclosed herein.

Other variants or applications of the disclosed techniques may become apparent to a person skilled in the art once given the disclosure herein. The scope of the disclosure is not limited by the described embodiments but only by the accompanying claims.

1. A system comprising: a set of multiple simulators wherein either: a) each of the simulators is arranged to perform a different respective trial of a simulation of a same physical phenomenon, orb) each of the simulators comprises a different instance of a piece of software arranged to automatically perform a different trial of a simulation of using a same functionality of the software; and
a control interface configured to collect respective simulation results from at least some of the set of simulators, and return the collected simulation results to a consumer, the consumer comprising a machine learning algorithm arranged to train a machine learning model using the simulation results supplied by the control interface;
wherein the control interface is further configured to detect a state of each of the simulators, and in response to detecting a faulty state of a faulty simulator from amongst the set of the simulators, reset the faulty simulator.

2. The system of claim 1, wherein the faulty state comprises a non-responsive state whereby the faulty simulator does not respond to the control interface including not returning simulation results.

3. The system of claim 2, wherein the control interface is configured to so as, upon detecting the non-responsive state of the faulty simulator, to continue collecting simulation results from others of the simulators while waiting for the faulty simulator to reset.

4. The system of claim 1, wherein each of the simulators of said set is arranged to perform its respective simulation under control of a first instance of the machine learning model in order to generate the respective simulation results; and the control interface is further arranged to receive an updated instance of the machine learning model updated based on said training by the machine learning algorithm, and send the updated instance to each of the simulators in the set; and wherein each of the set of simulators is further arranged to generate one or more further results based on the updated instance of the machine learning model.

5. The system of claim 1, wherein the control interface is configured to perform said collection of simulation results based on one or more query requests from the consumer.

6. The system of claim 1, wherein the piece of software which each of the simulators is each configured to simulate comprises a computer game.

7. The system of claim 6, wherein the machine learning model comprises at least part of at least one artificial intelligence agent being trained to play the computer game, the different circumstances comprising different values of one or more game inputs.

8. The system of claim 1, wherein the control interface is configured so as, in event of detecting the faulty state, to supply a last-collected simulation result from the faulty simulator to the consumer.

9. A system of claim 1, wherein the control interface is further configured to add simulators to said set and/or remove simulators from said set.

10. The system of claim 9, wherein the control interface is configured to remove one or more of the simulators from the set in response to a computing resource allowance or target for the set being reduced.

11. The system of claim 9, wherein the control interface is configured to add one or more simulators to the set in response to a computing resource allowance or target for the set being increased.

12. The system of claim 9, wherein the control interface is configured to remove the faulty simulator from the set in response to detecting at least one repeated failure of the faulty simulator after being reset.

13. The system of claim 1, wherein the control interface is further configured to periodically reset each of the simulators in said set.

14. The system of claim 1, wherein the simulators are run across multiple virtual machines distributed across a plurality of physical server units of a distributed computing platform.

15. The system of claim 14, wherein the simulators are implemented on one or more clusters, each cluster being a group of heterogeneous load-balanced virtual machines.

16. The system of claim 1, wherein the control interface is further configured to send data to one or more of the set of simulators to update the one or more simulators.

17. The system of claim 1, wherein the simulators of said set are grouped into subsets of simulators wherein within each subset the simulators interact with one another; and
wherein the control interface is configured so as in response to detecting the faulty state of the faulty simulator in one of the subsets, to reset all the simulators in the same subset as the faulty simulator.

18. A computer-implemented control interface for controlling a set of multiple simulators wherein either: a) each of the simulators is arranged to perform a different trial of a simulation of a same physical phenomenon, orb) each of the simulators comprises a different instance of a piece of software arranged to automatically perform a different trial simulation of a same functionality of the software; the control interface comprising:
an experiment manager;
an application programming interface, API, between the experiment manager and simulators; wherein the experiment manager is configured to collect simulation results from at least some of the set of simulators via the API, and return the collected simulation results to a consumer of the simulation results, the consumer comprising a machine learning algorithm being arranged to train a machine learning model using the simulation results supplied by the experiment manager; and
a stability manager configured to detect a state of each of the simulators, and in response to detecting a faulty state of a faulty simulator from amongst the set of the simulators, reset the faulty simulator.

19. A method of controlling a set of multiple simulators wherein either: a) each of the simulators is arranged to perform a different trial of a simulation of a same physical phenomenon, orb) each of the simulators comprises a different instance of a piece of software arranged to automatically perform a different trial of a simulation of a same functionality of the software; the method comprising:
collecting simulation results from at least some of the set of simulators;
supplying the collected simulation results to a machine learning algorithm, thereby causing the machine learning algorithm to train a machine learning model based on the simulation results;
detecting a state of each of the simulators in the set; and
in response to detecting a faulty state of a faulty simulator from amongst the set of the simulators, reset the faulty simulator.

20. A computer program embodied on a non-transitory computer-readable medium or media, the computer program comprising code configured so as when run on one or more processors to perform the operations of claim 19.
